(19) United States
(12) Patent Application Publication
(10) Pub. No.: US 2004/0187920 A1
(43) Pub. Date: Sep. 30, 2004

(54) Valve assembly for an internal combustion engine and method of manufacturing

(76) Inventors: Roman Schmidt, Upper Ferntree Gully (AT); Sam Soubjaki, Troy, MI (US)

Correspondence Address: Ronald E Greigg, Greigg & Greigg, Unit One, 1423 Powhatan Street, Alexandria, VA, 22314, US

(21) Appl. No.: 10/276,146

(22) PCT Filed: Mar. 14, 2002
(86) PCT No.: PCT/EP02/02857

(30) Foreign Application Priority Data
Mar. 15, 2001 (AU) PR 3749

(51) Int. Cl. F16K 1/22

(52) U.S. Cl. 137/15.25; 251/305

(57) ABSTRACT

The present invention is related to a valve assembly and a method of manufacturing same. An extruded profile is used as a housing of the valve assembly, within said housing a single-component valve-element is injection-moulded, having a shaft-part and a plate-part, by moulding said single-component valve-element within a central bore against said housing during injection-moulding. Curing of the single-component valve-element and contracting thereof is allowed, providing for a clearance between the single-component valve-element and components of said housing for relative movement therebetween.

### FIELD OF THE INVENTION

In the automotive industry valve assemblies are commonly used to control air flows or exhaust gas flows, or the like, to mention but a few. Valve assemblies, both mechanical and electronically operated are used as fluid valves for liquids and gas or as charged air recirculation valves, otherwise known as overrun-valves. Valve assemblies for the automotive industry in general are manufactured in larger series, i.e. volumes of more than 200.000 units per year.

### BACKGROUND OF THE INVENTION

It is known in the automotive industry, to provide for a valve assembly in the form of a throttle valve comprising a number of separate components, including a precast valve housing, a valve plate such as a butterfly plate and a shaft with bearings onto which the valve plate is mounted for rotation within its housing. The throttle valve is also provided with a throttle lever coupled to the shaft for controlling the position of the valve body within the housing. The throttle valve may also be operated electronically through a motor. The closed condition of the valve, referred to as idle-air-flow-position” hereinafter, is set by means of screw adjustment of the throttle lever. The throttle valve assembly is usually mounted directly to an engine block of an internal combustion engine. Subsequently, an intake duct or air filter is clamped onto the housing for completing the installation of the assembly.

EP 575 235 B1 is related to a rotary throttle member for a fuel admissions system of an internal combustion engine. The rotary throttle member according to this publication comprises a shaft, having cylindrical end portions, arranged in a length to receive a butterfly valve member. The length of the shaft has a constant cross-section which has no rotational symmetry and which is higher than the cross-section of the hole portion of the shaft located on one side of the length. The butterfly valve member has a central opening, the cross-section of which corresponds to that of said length. The complete shaft is a synthetic material moulding, integral with a cam member for connection with and winding of a control cable located on the other side of the length. The butterfly valve member according to this solution is of loaded synthetic matter. The loaded synthetic matter is preferably a thermoplastic. According to this solution, the butterfly valve member is secured to the length of said shaft by means of ultrasonic welding.

DE 101 05 526.9 discloses a device for controlling the feed of gas and a method for manufacturing the device. A shaft member is provided with bearing elements on the respective end portions of said shaft. That pre-assembled arrangement subsequently is mounted within an injection moulding device, in which said pre-assembled arrangement comprising said shaft, to the end portions of which the previously mentioned bearing elements are mounted, is being injection moulded according to a 1-component injection moulding method. During these procedure, the butterfly valve element is formed simultaneously with housings surrounding said bearing elements assigned to the respective end portions of the pre-assembled shaft arrangement. Thus, ultrasonic welding between said butterfly valve member and said shaft of the throttle element can be eliminated, which however is necessary according to the disclosure in EP 0 575 235 B1, previously discussed.

DE 197 03 296 A1 discloses a method for sealing a butterfly valve member on a throttle shaft. According to this solution, clearances between the outer circumference of this shaft and the respective inner diameter of a housing are provided with a hardening sealing liquid. That hardening sealing liquid inhibits an air flow otherwise escaping through said clearances.

Further there is known a throttle unit assigned to an internal combustion engine. According to this arrangement, a housing is provided into which an electrical driving unit is arranged. That electrical driving unit engages a butterfly valve member allowing for a rotational movement thereof To reduce the amount of manufacturing costs and to keep large variety of customer-related features, said housing is surrounded by a modular element. To said modular element a body, including a central bore of the intake duct is separately mounted.

DE 195 25 510 A1 discloses a throttle element unit which among other purposes is suitable for a E-gas-unit on an internal combustion engine. The throttle element unit comprises a central bore through which a flow of air or a fuel/air mixture passes. A housing is provided, which is closed by a lid-element for mounting of an electrical driving unit therein.

Conventional valve designs manufacture involves casting of an aluminum alloy housing which is followed by machining and assembly. Conventional valve design however, is limited by manufacturing processes in terms of achieving an extremely low air flow in said closed position (hereinafter referred to as “idle air flow-position” in regards to throttle bodies). Even with high precision machined plates and aluminum bores, low air flow is still possible at the expense of risking plate jamming in the fully closed position of a butterfly-shaped valve member. Air leakage around the shaft is also a major contributor to the overall closed plate leakage. As an alternative to aluminum housings, the use of plastic has advantages in terms of material property, thermal conductivity and manufacturability. There are, however, some disadvantages associated with moulded plastic components, such as post mould shrinkage, creep, swell and deformation. Attempts have been performed to eliminate those drawbacks by use of sleeving, machining or broaching of a metallic bore to maintain the fine tolerances required for low flow applications. Still further, after complete throttle valve assembly, the idle air flow must be set. Mechanical throttle bodies require a very sensitive predefined idle air flow setting position of the throttle plate which is conventionally adjusted and set using a threaded screw. This adjustment usually is performed by turning a screw whose linear motion causes the interfacing of a lever to rotate and thus adjusting the throttle plate radially and therefore the clearance between the plate and the bore. The clearance between the plate and the bore is crucial for the air leakage, at a predetermined pressure differential before and after the plate. This adjustment normally is set once and made tamper proof before leaving the factory.

### OBJECTS OF THE INVENTION

It is an object of the present invention to provide an alternative valve assembly construction with a reduced number of component parts and/or which may be more easily installed or assembled.

Still another object of the present invention is to achieve cost advantages provided by a aluminum extrusion manufacturing method compared to the die-casting of aluminum alloy housings of valve assemblies.

An additional object of the present invention is to overcome the disadvantages, associated with moulded plastic components such as post mould shrinkage, creep, swell and deformation.

A further object of the present invention is to utilize the advantages of plastic only in those crucial areas, such as the butterfly valve member and the shaft combining with durability, strength and dimensional stability of a metal material, a composite material. Another additional object of the present invention is to eliminate the need for an additional set screw, used for setting a sensitive predefined idle air flow position of a butterfly-shaped valve element of a valve assembly.

### SUMMARY OF THE INVENTION

In accordance with one broad aspect of the invention, there is provided a method of forming an assembly for a valve, having a housing, injection moulding a part within the housing wherein the part is moulded against the housing during the invention moulding and allowed to contract during curing to provide a clearance between the part and the housing for relative movement therebetween.

Preferably, the part is in the form of a valve body with an integrally moulded shaft and the shaft projects through the housing, the method further including determining a closed condition of the valve body and fixing a lever to the shaft, for controlling the position of the valve body within the housing, the lever being fixed to the shaft at an end of travel position relative to the housing when the body is in the closed condition.

In another broad aspect, there is provided an assembly including a housing; and a part moveably mounted within the housing, the part being formed by injection moulding. Preferably, the housing is formed of metal and the moveable part is formed of plastics material. Preferably, the part is in the form of a valve body with an integrally moulded shaft. The assembly further may include a lever arrangement coupled to the shaft, for controlling the position of the valve body within the housing, the lever arrangement being fixed to the shaft such that the valve body is in a closed condition when the lever is at an end of travel position relative to the housing.

In another aspect, there is provided a method for setting an idle position for a valve, including positioning a valve body in a closed condition within a valve housing and coupling an actuating arrangement to the shaft, for controlling the position of the valve body within the housing, wherein the lever arrangement is fixed to the shaft at an end of travel position relative to the housing when the valve body is in the closed condition.

Preferably, the method includes providing at least one stop on the housing for engaging the lever arrangement and defining the end of travel position. In yet another aspect, there is provided an assembly including a housing, a valve body movably mounted within the housing and a lever fixed relative to the valve body, for controlling the position of the valve body within the housing, wherein the assembly includes a stop arranged to engage a lever arrangement and define an end of travel position, when the lever is rotated in a first direction relative to the housing, the end of travel position corresponding to the valve body being in a closed condition.

Preferably, the assembly may include a second s top for engaging the lever arrangement and defining a second end of travel position, when the lever arrangement is moved in a second direction, away from the first stop, the second end of travel position corresponding to a fully open condition of the valve body (wide-open position).

In a further aspect, there is provided a method of installing a valve assembly, including placing the valve assembly between a duct and a structure to allow for fluid communication between the duct and structure through a bore of the assembly and fixing the duct to the structure with fasteners by passing the fasteners through apertures in a housing of the assembly, so as to secure the assembly therebetween.

According to the present invention, generic defects associated with convention butterfly type valve designs are improved or entirely eliminated with the use of a single injection moulded shaft and plate configuration, i.e. the single-component valve element into a housing which preferably is an extruded profile of an extrudable material such as aluminum alloy. An injection moulding of a single-component valve-element having a shaft-part and a plate-part into a housing of metal material, the volume of high performance engineering plastics is on the one hand minimized and on the other hand, the durability strength and dimensional stability of aluminum is used. Thus by the manufacturing process according to the present invention lower idle-air flow can be realized without running the risk of plate jamming of the single-component valve-member in its fully closed position. As a result, the idle air flow leakage around the circumference of the plate-part and in the through bore, receiving the end portions of the shaft part are minimized and consequently the over all closed plate leakage. Further, drawbacks such as use of sleeving, machining or broaching of a metallic bore to maintain the fine tolerances required for low flow applications along with the requirements of expensive polymers for manufacturing of the single-component valve-member are eliminated. Further advantages of the present solution beside in the fact, that a almost 100% plate and bore match can be realized also allowing for a non-cylindrical bore profile or cross section. Due to the injection-moulding of the single-component valve member within said housing a separate throttle plate as well as a separate shaft and the assembly thereof can be entirely eliminated. A further significant advantage is the fact, that now due to the manufacture by injection moulding of the single-component valve-element within its housing non circular geometry's of a central bore and the respective actuatable throttle-element due to space constraints are possible. A still further advantage according to the solution of the present invention results in the fact that the entire assembly cycle time and the number of components are significantly reduced.

The extrudable profile, serving as the housing of the valve assembly according to the present invention, further comes along with the advantage that the mechanical properties of a two dimensional profile extruded body are significantly improved as compared to die-cast aluminum alloys. No porosity in the bore and bearing areas will occur. It has to be taken into account that the costs of die-casting a geometry in three dimensions are much higher than those of a two dimensional profile which is manufactured of an extrudable material. Further, said extrudable body can be very easily cut to the respective length in which it is needed.

According to another aspect of the present invention, a setting screw to fix the idle air flow position can be entirely eliminated and instead the fixing of the shaft-part of the single-component valve-element to an actuating device such an electrical drive a cam/lever element or a mechanical gearing can be coupled externally outside said housing after adjustment is being made. The idle air flow position can either be set through air flow measurement of the clearance between the plate-part and the bore, whereas the lever/cam assembly is fixed onto the shaft-part of the single-component valve-element by laser-welding, ultrasonic-welding or gluing or the like. Since the adjustment is performed externally of the housing of said valve assembly according to the invention the result is a higher resolution of sensitivity. In addition to the elimination of the need for an additional screw and eliminating the need of a threading operation or insert moulded threaded bushes into the housing a single-component valve-element having a plastic shaft and an plastic plate optionally being provided with a reinforcing structure can be used without the need to sleeve and bush.

### BRIEF DESCRIPTION OF THE DRAWINGS

The invention now is described in greater detail, by way of non-limiting examples only, with references to the accompanying drawings, in which:

FIG. 1 shows a perspective view of the housing of a valve assembly,

FIG. 2-shows the housing according to FIG. 1, however provided with bores and ducts of different diameter,

FIG. 3 is a perspective top view of the housing provided with an injection moulded butterfly valve member in its closed position.

FIG. 4 shows a partial perspective view showing a first end of travel position of the butterfly-shaped valve member within a central bore,

FIG. 5 is a partial perspective view showing a second end of travel position of the butterfly-shaped valve member within a central bore of the valve assembly,

FIG. 6 is a perspective view of a valve assembly according to the present invention, the arrow indicating a throttle plate rotation direction from idle air flow position to wide-open position and

FIG. 7 is an explosive view illustrating mounting of the assembly on an engine air intake manifold.

### DESCRIPTION OF THE PREFERRED EMBODIMENTS

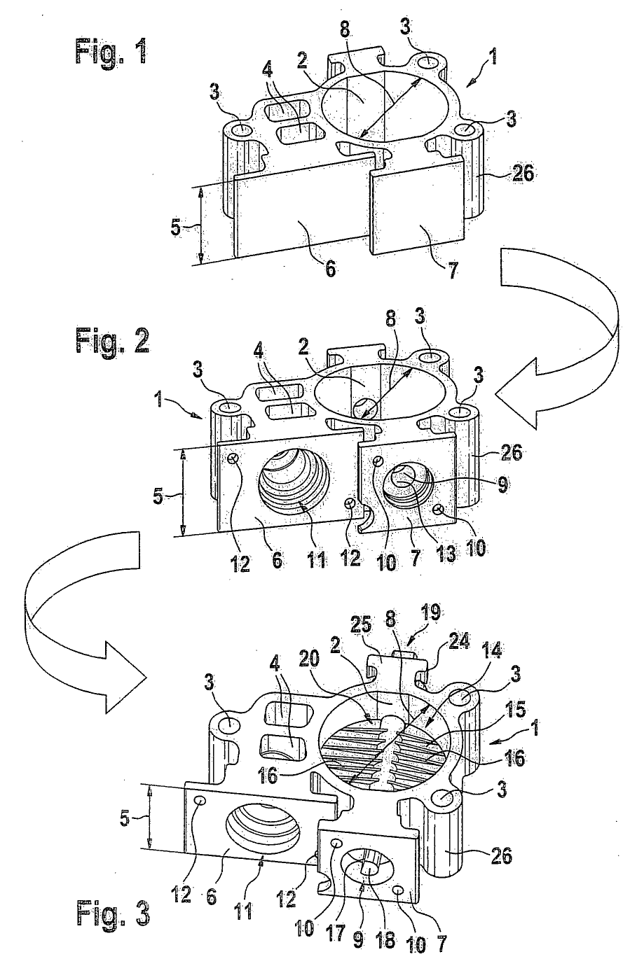

FIG. 1 shows a perspective view of the housing of a valve assembly.

A valve assembly includes a housing 26, a movable part 14 (single component throttle-element), in the form of a butterfly throttle-member 15 and a shaft and a lever 30, coupled to the shaft to control the position of a butterfly throttle member 15 within the housing 26.

The assembly is formed by firstly providing the housing 26, which is preferably an extruded profile 1 of a metal material, such as aluminum alloy, with a central bore 2 and various machined features such as stops 24 and 25, respectively for defining first and second end of travel positions for the lever 30, respectively and a through-bore 9. The moveable part 14, previously mentioned is then formed within the housing 26 by injection moulding plastics material in the central bore 2. For that purpose, the plastics material is injection moulded in numerous areas, which may include through bore 9, so that a butterfly throttle-member 15 and shaft are integrally formed, with the shaft being supported directly on bearing surfaces 13 defined by the through-bore 9 within the housing 26 being manufactured as an extruded profile 1.

The application of injection moulding, in this instance, provides a plastic part within a metal housing. Although it is generally known to injection mould plastics about metal components, as in the case of electrical connectors or the like, such moulding has been for the purpose of adhering the plastics material to the metal. The present invention, on the other hand, actually makes use of the plastics material contracting during curing to provide clearance and separation between the plastics material and the metal, to thereby allow for relative movement therebetween. The use of injection moulding also allows for a high degree of dimensional matching between the housing 26 and the moveable part 14 (single-component throttle element), which may not otherwise be present if the moveable part 14 is manufactured independently and separately, respectively.

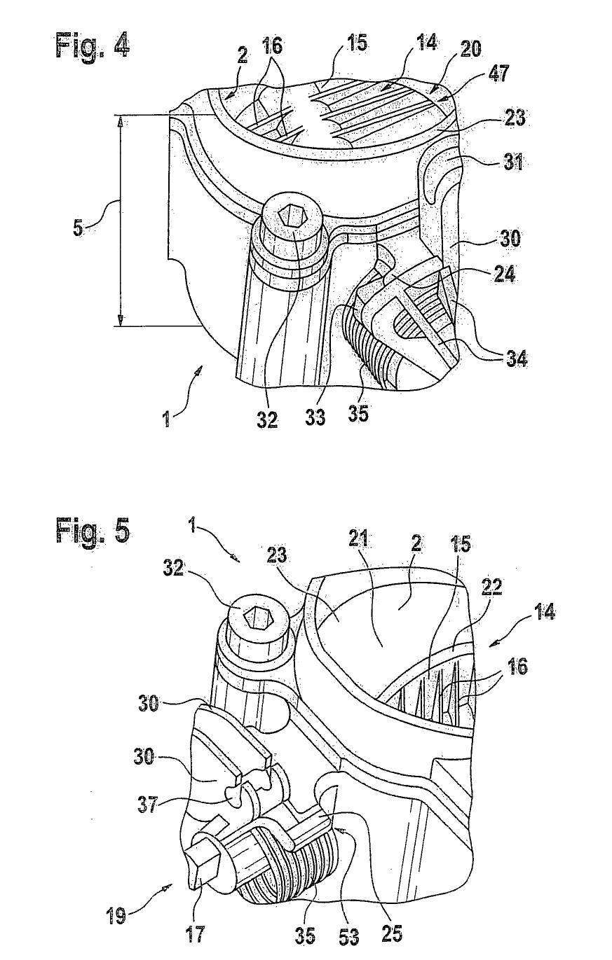

Subsequent to formation of the single component throttle element 14, the lever 30 is coupled to the shaft of said single component throttle element 14, in order that positioning of the butterfly throttle-member 15 and housing 26 may be controlled. To that end, lever 30 is firstly mounted to the shaft for free rotation relative thereto and the closed position 20 of the butterfly throttle member 15 is determined. When the butterfly throttle-element 15 is closed, i.e., the butterfly throttle member 15 which serves as single component throttle plate 14, is rotated into a closed set position 20 relative to the housing 26, where a first stop 24 formed on the housing 26, a boss 33 (idle air flow physical stop) is engaged on the lever 30, to define a first end of travel position of lever 30, lever 30 being rotated in a first, clock-wise direction for instance. (The first end of travel position is shown in greater detail in FIG. 4). Lever 30 is then fixed to the shaft of moveable part 14 at a connection 36 of lever 30 and shaft to accomplish a set position such as by welding or gluing, to give examples. A cost effective and process friendly method of permanently fixing the lever 30 onto the shaft of the single component throttle element 14, i.e. the butterfly shaped throttle member applied after “idle air flow setting” is achievable by means of mechanically locking the two components using either a solid rivet or split pin. The method is described as follows.

After the butterfly-shaped throttle member 15 and the lever 30 have been set in their required relative positions, a hole can be drilled between their mating surfaces and a pin is subsequently inserted with an interference fit to mechanically lock the two components together. The pin may be either recessed or flush with the two components for tamper-proofing purposes.

Accordingly, the closed condition 20 of the butterfly-shaped throttle member 15 relative to housing 26 may therefore be accurately set. The fully open condition 21 (wide open position) of the butterfly-shaped throttle member 15 is also determined, when the lever 30 is fixed to the shaft, as a result of a second stop 25 providing a second end of travel position for lever 30 when the lever 30 is rotated into a second direction, i.e. counter-clockwise direction, as viewed. The second end of travel position of said lever 30 is shown in greater detail in FIG. 5.

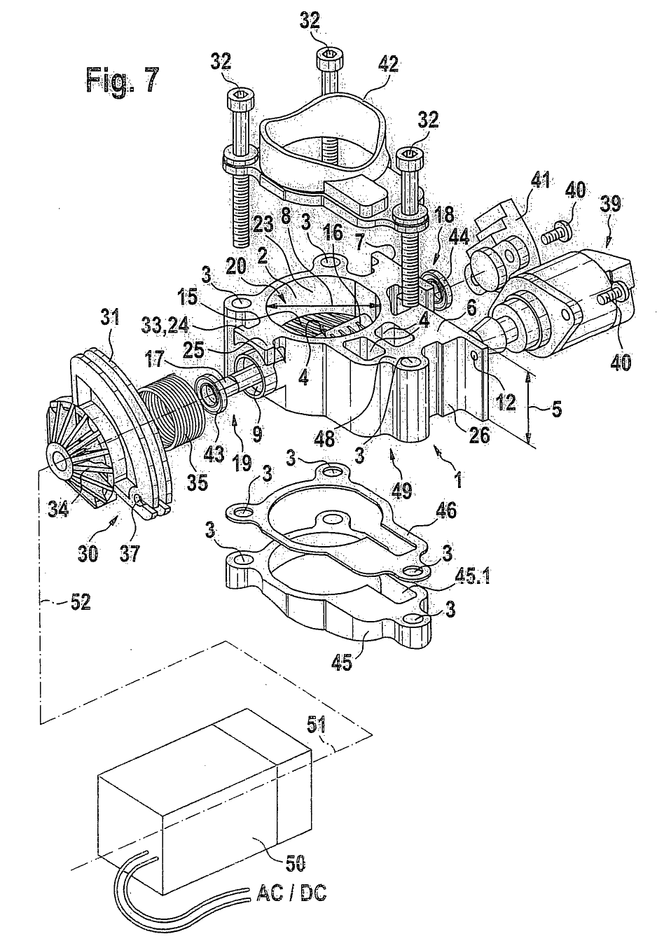

The valve assembly may then be transferred to a further production stage for eventual installation, serving as a throttle device in a vehicles engine such as an internal combustion engine. For example, any suitable component, such as an intake duct 42 (see FIG. 7) or associated flanges may be fixed onto the housing 26 in a conventional manner, for instance by the use of hoses. The component may be made using manufacturing processes such as injection moulding, die casting or deep draw to name a few. This component may also be fixed onto an assembly using one of many methods such as interference fit or with the use of screws or bolts to name a few. Alternatively, as shown in FIG. 7, the intake duct 42, which is shown as a section only (the feature of the duct 42 may of course be in the form of any other suitable structure such as a cover plate or cap which interfaces with an intake tube, or the like, if that is appropriate), itself may be directly mounted onto the housing 26, via fasteners 32, which pass through mounting holes 3 in the housing 26, directly onto an intake manifold through to the engine 45, so as to sandwich the extruded profile 1 therebetween. The intake duct 42 will, of course, be provided with a necessary geometry 46 to seal and cover bypass channels 45.1 as can be derived from FIG. 7, also formed in the housing 26 being preferably manufactured as an extruded profile 1. The intake duct 42 may or may not incorporate an air filter box. Accordingly, the assembly may form part of an apparatus, including the duct 42 and appropriate fasteners 32, which provide an added advantage of eliminating an extra duct clamp and mounting operation which the assembly would otherwise have needed to be independently mounted onto the manifold 45.

The apparatus also provides the added assurance, that the engine will be more difficult to operate without having both the valve assembly and intake duct 42 installed, thereby reducing the risk of unfiltered air entering the combustion chambers of the cylinders of internal combustion engine. It should be appreciated that the invention although described with reference to a throttle valve, need not to be so limited, since it clearly has application to other forms of valve assemblies. Further, the assembly itself need not actually be a valve assembly as such, since the broader concept of injection moulding a part internally of a metal housing, for movement there within, clearly has relevance to assemblies other than valve assemblies.

In any event, however, in the case of a throttle valve, it should be appreciated that the invention minimizes the number of separate component parts, as compared to the known forms of throttle valves, and that in turn leads to simplified construction and reduced production costs. Also, the manner in which the lever 30 is fixed to the shaft of the single component throttle element 14 allows for a quick and reliable setting of the closed position 20 of the butterfly-shaped throttle member 15 as compared to the known lever arrangements which, again, require more component parts, due to the screw-type adjustment technique.

As can be derived from FIG. 1 further, an extruded profile 1 of an aluminum alloy is machined during various process steps as indicated by the arrows. The extruded profile 1 comprises a central bore 2 as well as mounting holes 3 for fastening elements. Further, bypass passages 4 are integrated into the respective extruded profile 1 which is cut to the required length as indicated by reference numeral 5. The housing 26 according to FIG. 1 being an extruded profile 1 preferably of an aluminum alloy provides for superior mechanical property as compared to housings which are die casted. Further, on said extruded profile 1 according to FIG. 1 a first plane face 6 and a second plane face 7 are machined, which serve as mounting surfaces for further components of the throttle assembly according to the present invention, of which, according to FIG. 1, only the housing 26 being an extruded profile 1 of an aluminum alloy is shown. The inner diameter of said central bore 2 of housing 26 is indicated by reference numeral 8.

FIG. 2 shows the housing according to FIG. 1, however provided with bores and ducts of different diameter.

According to a further process step of machining of said extruded profile 1 forming the respective housing 26 of an throttle valve assembly—to give an example—said first plane face 6 and said second plane face 7 are provided with bores. Into the first plane face 6 opening 11 is machined having a plurality of diameter-steps into which a potentiometer or the like can be integrated. The provided bore 11 accommodates an idle air control valve (IACV) for a mechanical throttle body arrangement. These bores are not required if the respective throttle is driven electronically by use of an AC/DC motor.

Further, said first plane face 6 comprises fastening bores 12, which optionally can be provided with a thread to allow for mounting of additional components onto the first plane face 6. Said second plane face 7 is penetrated by an axial bore 9 the circumference of which forms bearing surfaces 13 for the shaft of the single component throttle element 14, such as a butterfly-shaped throttle member 15 (see FIG. 3). The second plane face 7 likewise is provided with fastening bores 10, which optionally can be provided with internal threading, to allow for fastening of actuating devices of said shaft, to be mounted within said through-bore 9 penetrating the central bore 2 of the housing 26 being a extruded profile of an aluminum alloy, or the like.

FIG. 3 is a perspective top view of the housing provided with an injection moulded butterfly valve member in its closed position.

According to FIG. 3, a single component throttle element 14 in the shape of a butterfly throttle-member 15 is integrated into said axial through bore 9 and manufactured therein by means of injection moulding. By this method of manufacturing a single-component throttle-element 14 can be achieved, comprising the shaft, penetrating the width of said central bore 2 and having assigned thereto the throttle plate which can be reinforced by a reinforcing structure 26, such as longitudinally extended ribs or the like. It should be noted, that said butterfly-shaped throttle member 15 is injecting moulded within the housing 26 of the valve assembly, being an aluminum alloy extruded profile 1. A single injection mould of shaft and plate of a butterfly-shaped throttle member 15 into an aluminum alloy housing 26 as given in FIG. 3 uses the advantages associated with moulded plastic components, i.e. post mould shrinkage is utilized to provide the necessary clearances. The use of sleeving, machining, broaching of the metallic bore to maintain the fine tolerances required for low air flow application along with the requirements of use of expensive polymers can be overcome. By means of the present invention those generic defects associated which conventional butterfly type valve designs can be entirely eliminated.

Due to the single component concept of the plate-part and the shaft-part of the single component throttle element 14, which may be shaped as a butterfly throttle member 15, a closed plate leakage 47 in the idle air flow position 20 of the single component throttle clement 14 can be minimized close to zero due to the very small manufacturing tolerances between the outer circumference 22 of the plate-part of the single component throttle element 14 and the innerwall 23 of said central bore 2 of said extruded profile 1, forming the housing 26 of the valve assembly according to the present invention. Even with high precision machined plates and aluminum bores, low air flow still occurs at the expense of risking plate jamming in the fully closed position 20. Due to the invention closed plate leakage, as indicated by arrow 47 in FIG. 3, which normally occurs with conventional valve assembly designs, can be minimized.

Said extruded profile 1 comprises at a second shaft-end 19 of the shaft of the single-component throttle-element 14 bosses, a first stop 24 and a second stop 25. Said stops 24, 25, respectively, define the first end of travel position 33 and the second end of travel position 53 of a lever element 30, which is given in greater detail in FIGS. 4, 5, and 6, respectively.

The major advantages of the embodiment according to the present invention given in FIG. 3, involve plastic injection moulding of a shaft and a plate of a single-component throttle-element 14, having for instance a butterfly-shaped configuration 15 into a metallic body, such as a housing 26 manufactured of an extruded profile 1 of an aluminum alloy. Thereby, the volume of high performance engineering plastics to be used is minimized and further, the durability, the strength and the dimensional stability of aluminum can be used. The advantages of this solution are to be seen in a low cost manufacturing and a 100% plate and bore match of the single-component throttle element 14 with the innerwall 23 of said central bore 2 of the housing 26. Low close plate leakage 47 and therefore idle air flow can be achieved with the solution according to the present invention. Bore-sleeving or machining operations to be performed to maintain bore concentricity and cylindricity can be completely eliminated. By use of the single injection concept of manufacturing said plate-part and said shaft-part of the single-component throttle-element 14 according to the present invention a separate throttle plate as well as a separate shaft can be eliminated. As a further consequence, the assembly of separate shaft and plate elements of the throttle member can be eliminated too. A further advantage of the solution according to the present invention is to be seen in-the fact that the central bore 2 penetrating the housing 26 being an extruded profile 1 of an aluminum alloy in axial direction can be manufactured non-circular. Due to the fact that said single-component throttle element 14 is manufactured within said bore 2 a perfect match between the outer circumference 22 of the single component throttle element 14, for instance being a butterfly-shaped throttle member 15 can be achieved allowing for minimum close plate leakage 47. Still further, the solution according to the present invention allows to decrease the entire assembly cycle time and the number of required components for a valve-assembly.

Said bearing surfaces 13 (see FIG. 2), being machined as outer circumference of said through-bore 9 of housing 26 can be coated with a lubricative additive, allowing for a smooth rotation of the shaft-part of said single-component throttle element 14 within the through-bore 9. Alternatively, lubricative additives such as PTFE may be formulated into the plastic polymer allowing the shaft to be self lubricating. According to the manufacturing technique, the shaft-part-plate of said single-component throttle element 14 which is moulded at an angle, will take on a 1 to 1 size and geometry of the through-bore 9. The material is being injected into the trough-bore 9 with an offset of shrinkage allowance. The importance of the through-bore 9 is that it provides both draft angle for the moulding tool and the clean shut-off face to avoid flashing. According to these manufacturing technique none cylindrical or non symmetrical bores can be used due to space constraints. Straight edges 18, 19 at shaft ends of the shaft-port of said single-components throttle element 14 can be achieved to reduce close plate leakage as indicated by arrow 47 in FIG. 3. Further, other components such as cams or gears can be integrated simultaneously as a single shot injection-moulding process. Due to the large variety of geometry's a valve-assembly not only for air applications but also for liquid applications are achievable.

FIG. 4 shows a partial perspective view showing a first end of travel position of the butterfly-shaped valve member with a central bore,

In FIG. 4 a idle air flow position 20 of said single-component throttle-element 14 is given in greater detail. The respective circumference 22 of said plate-part of said single-component throttle element 14 matches with the innerwall 23 of the central bore 2, minimizes closed plate leakage 47. Extending from said shaft-part of the single-component throttle element 14, reinforcing ribs 16 extend into radial direction. The length of the extruded profile 1 of an aluminum alloy, forming the housing 26 of the valve assembly is indicated by reference numeral 5. The length 5 is cut off the extruded profile 1 of an extrudable material as needed, which lowers manufactures costs considerably as compared to 3-D die-casting.

To a second shaft end 19 of the shaft-part of the single-component throttle element 14 a lever 30 is assigned. Said lever 30 comprises an annular recess 31 extending about an arc of 90°. The lever element 30 according to the embodiment of FIG. 4 comprises a reinforcing rib structure 34 and is pretensioned by means of a helical spring 35 mounted between the outer side-wall of the housing 26 and the inner-side of the reinforcing structure 34, assigned to the lever element 30. The intake duct 42, not shown greater detail here, is mounted by means of mounting screws 32, extending through the mounting holes 3 of housing 26. In the idle air flow position 20, given in FIG. 4, said lever 30 comprising an annular recess 31 for a control cable such as a Bowden-cable, is shown in its idle air flow position 20. In this position an idle air flow physical stop 33 abuts said first stop 24 being arranged on the housing 26 being an aluminum alloy extruded profile 1. In FIG. 5 on the other hand, a wide open throttle physical stop 53 of said lever element 30 abuts said second stop 25 provided on said housing 26 being in an extruded aluminum alloy profile 1.

According to this solution a setting screw to fix the idle air flow position 20 can be eliminated by instead fixing the shaft-part of said single-component throttle element 14 relative to a lever 30 or a cam—not shown here in greater detail—after adjustment. By providing two physical stops 33, 53 respectively, on lever 30, positioned at approximately 90° apart from each other, depending on the idle to wide open throttle rotating angle, the rotational movement of said single-component throttler-element 14 is defined. Said idle air flow physical stop 33 defines the idle air flow position 20 of said single-component throttle element 14, whereas the wide-open throttle physical stop 53 of said lever 30 defines the wise open throttle position 21. After assembly of the single-component throttle element 14, the lever 30—to give an example is placed on the shaft-part of the single-component throttle element 14 in its idle air flow position 20, i.e. being is in contact with the housing 26. The lever 30 at this pre-assembled stage is to allowed to move relative to the single component throttle element 14, having a butterfly-shape 15, arranged within the housing 26. Once the idle air flow has been set through either air flow measurement or clearance measurement between plate-part of that single component throttle element 14 and central bore 2, a lever 30/cam assembly is fixed onto the shaft-part of single component throttle-element 14 with any method that secures said components permanently. Examples of such techniques may be either laser-welding, ultrasonic-welding, glueing or the like. By appliance of these techniques, the set is not limited to the leverage of the lever 30/cam since the adjustment is performed externally, i.e. outside said housing 26 being preferably a aluminum alloy extruded profile 1, resulting in a higher relation of sensitivity.

FIG. 5 is a partial perspective view showing a second end of travel position of a butterfly-shaped throttle-member within a central bore of a valve assembly.

In the position of said single-component throttle-element 14 shown in FIG. 5, i.e. a wide open position 21, the diameter of the cross section of central bore 2 stands open. The circumference 22 of said plate-part of the single-component throttle element 14 is oriented perpendicular to the axial direction of said central bore 2. The flow of liquid or gas passing the central bore 2 is allowed to its respective maximum extent.

In the wide-open position 21 given in FIG. 5, said actuating element 30—being a lever/cam arrangement for instance—abuts with its wide-open throttle physical stop 53 said second stop 25 arranged on the outer side of said housing 26 of the valve assembly according to the present invention. Upon approximately 90°-rotation of said lever/cam arrangement 30 said helical spring 35 pretensioning the lever 30 is compressed to its maximum extent, thus exerting a counter force upon said lever 30 to move said lever 30 into its initial position. The lever 30 having a annular recess 31 for mounting of a control cable to be fixed in bore 37 rotates that's seconds shaft end 19 of a shaft-part of single-component throttle element 14 into an upright position. The second shaft end 19 is provided with a flattening 17 allowing for arrangement of an external drive such as an electrical motor. Besides the mechanical actuation of the single-component throttle-element 14—as given in the embodiments 4 and 5 of the present invention—the lever/cam arrangement 30 can be replaced by an actuating device such as an electric motor 50 as given schematically in FIG. 7. To the electrical drive 50 a gearing 51 arrangement may be assigned, by means of which the revolution of that electrical drive 50 can be adapted to the rotational movement required for actuating of said single-component throttle-element 14. The use of an electrical drive 50 for actuating the single-component throttle-element 14, having for instance a butterfly-shaped configuration 15 comes along with the advantage to integrate said valve assembly according to the present invention as an electronic accelerator, named E-gas function. Instead of having a control cable, such as a Bowden-cable mounted in the annular recess 31 of said lever 30 this arrangement can be replaced by an electrical drive 50 to be connected to the control unit of an internal combustion engine. Dependent upon the position of the accelerator-pedal in a vehicle, the electrical drive 50 assigned to the valve-assembly actuating the single-component throttle-element 14 the rotational position thereof within said central bore 2 of the valve assembly is controlled allowing a larger/higher amount of intake air to pass said central bore 2 of an intake induct 42 of an internal combustion engine.

Besides an E-gas function, the valve assembly according to the present invention can be used as an exhaust-gas recirculating valve, allowing for mixing an amount of exhaust gas to the fresh air, passing said induct air-intake 42 of an internal combustion engine. Since the exhaust-gas of an internal combustion engine has a higher temperature as compared to the temperature of the fresh air to be fed to the internal combustion engine, said single-component throttle-element 14 having an integrally formed plate and shaft as one piece is to be injecting moulded after mounting within said housing 26 using a heat-resistant thermal plastic material. The extremely small tolerances achieved between the outer circumference 22 of the plate-part of said single component throttle-element 14 according to the present invention mounted within said central bore 2 of housing 26 allows for a optimum seal between an exhaust gas recirculation system and the intake duct 42 of an internal combustion engine.

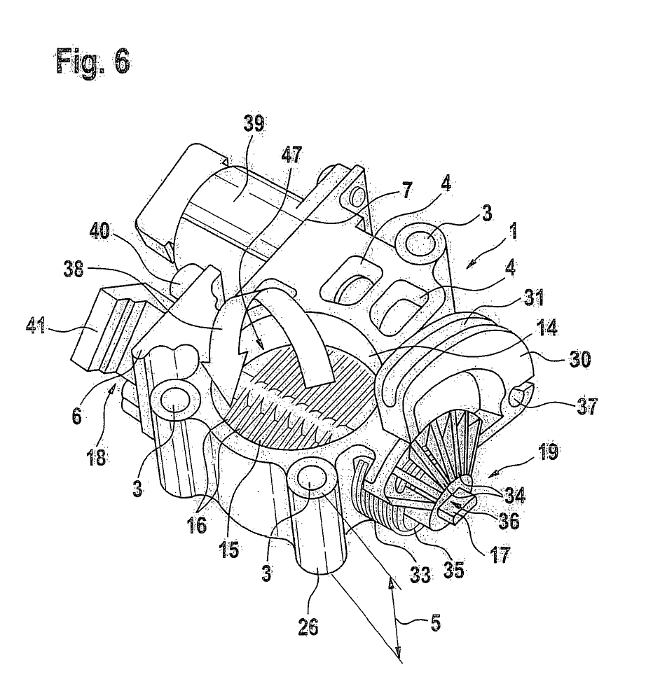

FIG. 6 is a perspective view of a valve assembly according to a present invention, the arrow indicating a throttle plate rotation direction form idle air flow position to wide open position and

According to this figure, said housing 26, preferably being formed as an extruded profile 1 of an aluminum alloy shows besides a lever 30 a idle air control valve 39 (IACV) used to control the air flow when the plate-shape part of the single-component throttle-element 14 is in the closed position, item 41 is a throttle position sensor (TPS) or in the alternative a potentiometer, used to detect the accurate throttle position with respect to its angular protection about the shaft-part of the single-component throttle element 14.

The rotational movement, which can be imposed on said single-component throttle-element 14 is indicated by arrow 38 according to FIG. 6. The amount of rotational movement, i.e. approximately a 90° arc—depends upon the position of the physical stops 33, 53 on lever 30, or respectively on the rotational movement defined by a gear arrangement 51 (see FIG. 7), to be assigned to an electrical actuating device 50 for actuating said single-component throttle element 14. Due to the injection moulding of said single-component circumference 22 of the plate part and the inner-wall 23 of said central bore 2 is close to zero, however preventing a jam between these components. By means of a throttle-position sensor 41 or a potentiometer rotational position of said plate-part of said single component throttle-element 14 can be detected, required for all engine throttling system to provide feedback to the Engine Control Module (ECM), particular for an E-gas concept, i.e. an electronic accelerator system. Likewise, a tracking rotational positioned of said plate-member a plate-part ofsaid single-component throttle-element 14 is useful in using the valve assembly according to the present invention as an exhaust gas recirculation valve assembly.

For various reasons, parallel to said central bore 2 bypass ducts 4 are extruded in the interior of said housing 26 being an extruded profile 1 of an aluminum alloy or the like. Reference numeral 36 identifies a connection located between said lever 30—to give an example—and said shaft-part of the single-component throttle-element 14. That second shaft end 19 of the shaft part of the single-component throttle-element 14 comprises a flat portion 17 which allows for a mounting of a gearing 51 or an electrical drive 50 (see FIG. 7) for actuating of the single-component throttle-element 14 having a butterfly-shape 15. The idle air control valve 39 and the throttle position sensor 41, in the alternative a potentiometer, respectively mounted on the respective first plane face 6 and the respective second plane face 7 of the housing 26 being an extruded profile 1. From FIG. 6 further can be derived, that a lever 30, having a idle air flow physical 33 abuts said first stop 24 of the housing 26 of the valve assembly. The position of lever 30 given in FIG. 6 corresponds to the position of said lever 30 given in FIG. 4 in greater detail. It should be noted that for connecting said lever 30 or another actuating device with the shaft-part of the single component throttle-element 14 methods as ultrasonic-welding, gluing or threading or inserting of pins can be used depending upon manufacturing considerations.

FIG. 7 is an explosive view illustrating mounting of the assembly on an engine block of an internal combustion engine.

FIG. 7 shows an exploded view of the components to be assigned to the housing 26 of a valve assembly according to the present invention, preferably being manufactured as an extruded profile 1 of an aluminum alloy or the like. Besides an extruded profile 1 of an aluminum alloy high temperature thermoplastics may also be used for the housing 26 which is an extrudable material as well. The single-component throttle-element 14 being injection moulded as an integral part within the central bore 2 of housing 26 is shown in its idle air flow position 20. In this position, a closed plate leakage 47 between the outer circumference 22 of a plate part of the single-component throttle-element 14 is minimized, although a jam of said single-component throttle-elements outer circumference 22 with the inner-wall 23 of the central bore 2 is prevented. To the first shaft end 18 and the second shaft and 19, respectively, ring-shaped members 43, 44 respective are assigned. Said ring-shaped members 43, 44 respectively may be shaped as O-rings or lip-seals to eliminate air leakage. On that second plane face 7 the throttle-position sensor or potentiometer through detect the angular throttle-plate-part's position is mounted by means of fastening elements 40 in a threading through bores in part 41 being fixed in fastening bores 10 optionally having an internal threading.

On the opposite of lever 30 having a rib-structure 34 and an annular recess 31 assigned to its outer circumference about an arc of approximately 90° is arranged. The lever 30 is pretensioned by means of a helical spring 35 to be mounted between said lever 30 and the second shaft end 19 of the shaft-part of the single-component throttle-element 14. On the second shaft end 19 further a flattened portion 17 is provided. Further, the housing 26 comprises a first stop 24 and a second stop 25, cooperating with either idle air flow physical stop 33 or wide-open throttle physical stop 53 assigned to said lever arrangement 30 according to one alternative of actuating said single-component throttle-element 14.

A idle air control valve 39 is used for precise air metering during idle-operation. By means this control valve 39 the engine kept at idle-RPM (such as 750 rpm) in all conditions. Conditions which may very the speed of the internal combustion engine are density, a power steering pump and a headlight switching on or other electrical/alternator loads. The idle air control vale 39 is mounted by means of fasteners 40 to that first plane face 6 provided with fastening openings 12, optionally being provided with an internal threading. The height of said housing 26 being an extruded profile 1 is identified by reference numeral 5.

Coaxial to a central axis 52 of said shaft-part of the single-component throttle-element 14 according to the present invention an electrical drive 50 can be arranged. To this electrical drive 50 optionally a gearing 51 can be assigned by which the revolution of said electrical drive 45 can be transferred to said shaft-part of said single-component throttle-element 14, having for instance a butterfly-shaft configuration 15 as given in FIG. 7. The arrangement of an electrical drive 50 to the central axis 52, engaging said flattened portion 17 on the second shaft end 19 allows for integration of the valve assembly according to the present invention into an electronic accelerator configuration by means of which said single-component throttle-element 14 is not mechanically activated but by means of the signal input from the accelerator-pedal of a vehicle. For transmission of the revolutions of the electrical drive 50 a gearing 51 advantageously is used which either can act directly upon said second shaft end 19 of the shaft part of the single-component throttle-element 14 according to the present invention. Alternatively, an arrangement of said gearing 51 offset to said central axis 52 of the shaft-part of single-component throttle-element 14 is feasible. A further use of the valve assembly according to the present invention is given by providing said valve assembly according to the present invention within an exhaust-gas recirculation valve. By means of an exhaust-gas recirculation valve a part of the exhaust gas of an internal combustion engine can be remixed to the intake duct 42 of an internal combustion engine to allow for preheating of the intake air and to allow for reduction of emissions of the exhaust-gas of an internal combustion engine. Of course appropriate materials must be so selected for this application.

On top 48 of said housing 26 preferably being an extruded profile 1 of an aluminum alloy said intake duct 42 can be mounted by means of mounting screws 32, penetrating said mounting holes 3 assigned to the housing 26. To the bottom 49 of said housing 26 a sealing element 46 is provided. Said sealing element 46 is sandwiched between the bottom 49 of said housing 26 and a manifold 45, comprising bypass channels 45.1 communicating with said bypass passages 4 integrated into the housing 26 of the valve assembly according to the present invention. On said intake duct 42 or the manifold 45, respectively hose connections either directly be mounted with conventional claiming techniques so as to provide a sealed flow of air, exhaust gas or the like trough the valve assembly, may it be used as a throttle-unit within in the intake duct 42 or maya be used as an exhaust-gas recirculation valve. Advantageously, an single-component throttle-element 14 driven by a schematically shown electrical drive 50 is to be integrated into an E-gas function, i.e. an electronic acceleration system of a vehicle. This would eliminate the need of a lever/cam arrangement 30 and eliminate the use of a control cable such as a Bowden-cable for actuating the lever/cam arrangement 30 causing a rotational movement of single-component throttle-element 14.

1-24 Cancel.

25. A method of forming a valve assembly, the method comprising:
providing an extruded profile (1) as a housing (26),
injection-moulding a single-component valve-element (14) having a shaft-part and having a plate-part within said housing (26),
wherein the single-component valve-element (14) is moulded within a central bore (2) against the housing (26) during injection-moulding, and p1 forming said extended profile from a material which will shrink during curing to achieve a clearance between the single-component valve element (14) and components (23, 13,9) of said housing (26) for relative movement therebetween.

26. Method according to claim 25, wherein said housing (26) is manufactured as an extruded profile (1).

27. Method according to claim 26, wherein said housing (26) comprises a central bore (2), bypass passages (4) and mounting holes (3) formed therein during extrusion.

28. Method according to claim 26, wherein said extruded profile (1) is manufactured from an aluminum alloy.

29. Method according to claim 25, wherein said single-component valve-element (14) is moulded by a plastic material with a lubricating additive.

30. Method according to claim 29, wherein during shrinkage and curing of said extended profile, said lubricative additive forms a bearing surface (13) between a shaft-part of said single-component valve-element (14) and a through bore (9) of said housing (26).

31. Method according to claim 29, wherein on a further feed step of plastic material, after forming said single-component valve-element (14) within said housing (26), components such as gears (51) or cams (17) are integrally moulded.

32. Method according to claim 26, wherein said extruded profile (1) is manufactured of an extrudable alloy.

33. Method according to claim 26, wherein said two-dimensional extruded profile (1) is manufactured of a composite material.

34. Method according to claim 29, wherein said plastic material for moulding said single-component valve-element (14) is a thermoplastic material.

35. Method according to claim 25, further comprising determining a closed position (20) of said single-component valve-element (14) resulting in a minimum idle-air flow.

36. Method according to claim 35, wherein said idle air flow is defined either by air flow measurement or by measurement of a clearance between an outer circumference (22) of said single-component valve-element (14) and an innerwall (23) of said central bore (2).

37. Method according to claim 36, further comprising coupling, an actuating device (30, 50, 51) for said single-component valve-element (14) to one shaft-end (18, 19), respectively of said single-component valve-element (14) in said closed position.

38. Method according to claim 37, wherein a permanent coupling between one shaft end (19) of a single-component valve-element (14) and said actuating device (30, 50, 51) is achieved either by laser-welding, ultrasonic-welding or by gluing.

39. Method according to claim 37, wherein a first stop (24) and a further stop (25), respectively, are assigned to said housing (26) cooperating with stop surfaces (33, 53) of an actuating device (30) assigned to said single-component valve-element (14).

40. Valve assembly manufactured according to the method of claim 25, the valve assembly comprising a housing (26) with central bore (92) in which a single-component valve element (14) is arranged, said housing (26) having a top (48) and a bottom (49) to which further components (42; 45, 56) are mounted, wherein said housing (26) is an extrudable profile (1) of a metal material, and into which profile a single-component valve-element (14) is integrally injection-moulded, and to one end (18, 19) of which an actuating device (30, 50, 51) is assigned.

41. Valve assembly according to claim 40, wherein said housing (26) comprises a first stop (24) and a further stop (25) assigned to one end (18, 19) of a shaft-part of said single-component valve-element (14).

42. Valve assembly according to claim 41, wherein said first stop (24) and said second stop (25) cooperate with abutting surfaces (33, 53) of a lever-shaped actuating device (30) for defining an idle air flow position (20) and a wide-open position (21) of said single-component valve-element (14) within said housing (26).

43. Valve assembly according to claim 40, wherein said actuating device is an electrical motor (50) assigned to a central axis (52) of said single component valve-element (14).

44. Valve assembly according to claim 43, wherein a gear-arrangement (51) is assigned to said central axis (52), cooperating with said electrical motor (50).

45. Valve assembly according to claim 43, wherein said valve assembly is an electronic accelerator unit (E-gas), controlling revolution and load of a vehicle's internal combustion engine depending on a drivers demand.

46. Valve assembly according to claim 43, wherein said valve assembly is an exhaust-gas recirculation valve, for feeding exhaust gas into an intake duct (42) of an internal combustion engine or a charged air re-circulation valve such as turbo-overrun.

47. Valve assembly according to claim 40, wherein said central bore (2) and said single-component valve-element (14) have a non-circular geometry.

48. Valve apparatus including an assembly comprising
a housing (26) which defines a central bore (2) and bypass channels (4) and through which apertures (3) pass,
a duct (42) for communication with said bore (2) and
fastening elements (32) to mount said duct (42) to the assembly fastening, said housing elements (32) being adapted to through-apertures (3) securing the assembly to a structure (45) in an intake- or exhaust system of an internal combustion engine, respectively.
